(19) United States
(12) Patent Application Publication
(10) Pub. No.: US 2023/0030788 A1
(43) Pub. Date: Feb. 2, 2023

(54) COMPUTER-READABLE RECORDING MEDIUM STORING TRANSLATION PROGRAM AND TRANSLATION METHOD

(71) Applicant: FUJITSU LIMITED, Kawasaki-shi (JP)

(72) Inventor: Takumi Honda, Kawasaki (JP)

(73) Assignee: FUJITSU LIMITED, Kawasaki-shi (JP)

(21) Appl. No.: 17/731,278

(22) Filed: Apr. 28, 2022

(30) Foreign Application Priority Data
Jul. 27, 2021 (JP) 2021-122797

(51) Int. Cl. G06F 9/30

(52) U.S. Cl. CPC G06F 9/3017

(57) ABSTRACT

A recording medium stores a program for causing a computer to execute processing including: incrementing a counter every time translating a CISC instruction into a RISC instruction; updating previously referenced translation timing of a register to be used for translation with a value of the counter; in a case where a use register number that stores a register number to be used for translation of the memory operand is an initial value, selecting the register number, and updating the use register number to the selected register number; in a case where the use register number is not the initial value, and when the use register number is not used, skipping data restoration and data saving for the register of the use register number, and generating an instruction to read data of the memory operand by using the register; and generating the RISC instruction equivalent to the CISC instruction.

### CROSS-REFERENCE TO RELATED APPLICATION

This application is based upon and claims the benefit of priority of the prior Japanese Patent Application No. 2021-122797, filed on Jul. 27, 2021, the entire contents of which are incorporated herein by reference.

### FIELD

The embodiment discussed herein is related to a machine language translation program and the like.

### BACKGROUND

A deep learning library optimizes functions at runtime and implements high-speed processing. Since a core function that greatly affects processing performance is developed in assembly code, the core function needs to be dealt with for each architecture. To reduce a development cost, there is a translator for translating an instruction of the core function from one architecture to another architecture. By using this translator, the instruction developed for complex instruction set computer (CISC) architecture can be translated into the instruction for reduced instruction set computer (RISC) architecture.

Japanese Laid-open Patent Publication No. 2012-226486 and U.S. Patent Application Publication No. 2020/0117454 are disclosed as related art.

### SUMMARY

According to an aspect of the embodiments, a non-transitory computer-readable recording medium stores a translation program for causing a computer to execute processing including: incrementing a counter every time translating a complex instruction set computer (CISC) instruction into a reduced instruction set computer (RISC) instruction; updating previously referenced translation timing of a register to be used for translation with a value of the counter when translating the CISC instruction with a memory operand into the RISC instruction; in a case where a use register number that stores a register number to be used for translation of the memory operand is an initial value, selecting the register number by a predetermined selection method, and updating the use register number to the selected register number, by using a register management table in which the register number and the previously referenced translation timing are associated with each other; in a case where the use register number is not the initial value, and when the use register number is not used in the translation into the RISC instruction, skipping data restoration and data saving for the register indicated by the use register number, and generating an instruction configured to read data of the memory operand by using the register indicated by the use register number; and generating the RISC instruction equivalent to the CISC instruction.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a functional configuration of an information processing device according to an embodiment;

FIG. 2 is a diagram illustrating an example of a register management table according to the embodiment;

FIG. 3 is a diagram illustrating an example of a reference idx according to the embodiment;

FIG. 4 is a diagram illustrating an example of a counter according to the embodiment;

FIG. 5A is a diagram (1) illustrating an example of translation processing according to the embodiment;

FIG. 5B is a diagram (2) illustrating an example of the translation processing according to the embodiment;

FIG. 5C is a diagram (3) illustrating an example of the translation processing according to the embodiment;

FIG. 5D is a diagram (4) illustrating an example of the translation processing according to the embodiment;

FIG. 5E is a diagram (5) illustrating an example of the translation processing according to the embodiment;

FIG. 5F is a diagram (6) illustrating an example of the translation processing according to the embodiment;

FIG. 6A is a diagram (1) illustrating another example of the translation processing according to the embodiment;

FIG. 6B is a diagram (2) illustrating another example of the translation processing according to the embodiment;

FIG. 6C is a diagram (3) illustrating another example of the translation processing according to the embodiment;

FIG. 6D is a diagram (4) illustrating another example of the translation processing according to the embodiment;

FIG. 6E is a diagram (5) illustrating another example of the translation processing according to the embodiment;

FIGS. 7A and 7B are a diagram illustrating an example of a flowchart of the translation processing according to the embodiment;

FIG. 8 is a diagram for describing effects of the translation processing according to the embodiment;

FIG. 9 is a diagram for describing a hardware configuration example; and

FIG. 10 is a reference diagram of translation of a CISC instruction with a memory operand into an RISC instruction.

### DESCRIPTION OF EMBODIMENTS

Here, the RISC is a method adopted by ARM (registered trademark) central processing units (CPUs). The RISC instruction is an instruction that use a register as an operand, assuming that there is data in the register. For example, there is “fmla zreg0,zreg,zreg2;” as an assembly code. This instruction represents a 512-bit multiplication/addition instruction “zreg0←zreg0+zreg1×zreg2”. For example, this instruction represents that values of the 512-bit vector registers zreg1 and zreg2 are multiplied, added to a value of zreg0, and stored in zreg0.

In contrast, the CISC is a method adopted by Intel (registered trademark) CPUs. The CISC instruction can specify a register and a memory address as operands with a single instruction. For example, there is “vfmadd231ps zmm0,zmm1,ptr[r10];” as the assembly code. This instruction represents a 512-bit multiplication/addition instruction “zmm0←zmm0+zmm1×ptr[r10]”. For example, this instruction represents that memory access is performed using the value of the 512-bit register r10 as an address, 512 bits are read and are multiplied with the value of 512-bit vector register zmm1, and a result is added to the value of the vector register zmm0 and is stored in zmm0.

However, there is a problem that execution performance is deteriorated when the assembly code written in the CISC instruction with the memory operand is translated into the RISC instruction. For example, an additional register is temporarily needed when the assembly code written in the CISC instruction with the memory operand is translated into the RISC instruction. To secure the register, a store instruction and a load instruction are issued to save the data stored in the register and restore the data to the register. An increase in the store instruction and the load instruction causes a decrease in processing speed and deteriorates the execution performance.

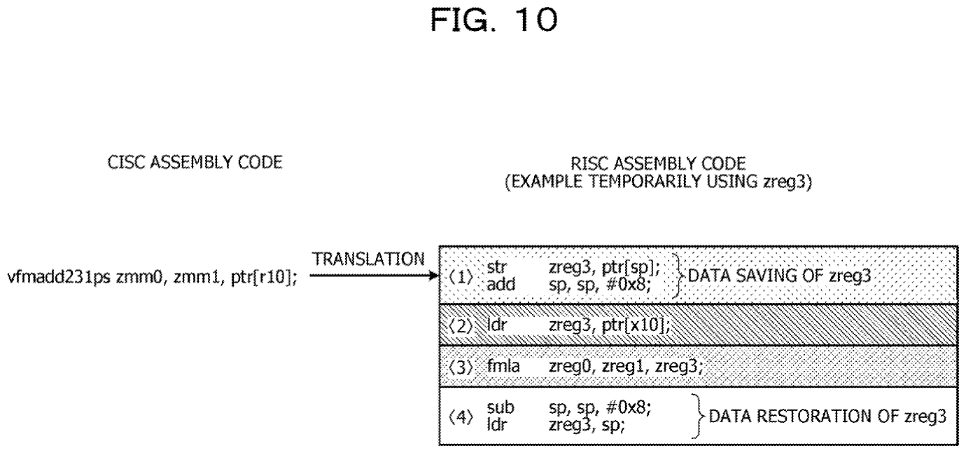

Here, the translation of the CISC instruction with the memory operand into the RISC instruction will be described. FIG. 10 is a reference diagram of the translation of the CISC instruction with the memory operand into the RISC instruction. As illustrated in FIG. 10, in a case where the CISC assembly code is “vfmadd231ps zmm0,zmm1,ptr[r10];”, the corresponding RISC assembly code becomes an instruction sequence <1> to <4> illustrated on the right. <1> To save the data, the data of the temporarily using specific register zreg3 is written in the memory (sp) using the store (str) instruction. <2> The data ptr[x10] treated as the memory operand is read into the specific register zreg3 using the load (ldr) instruction. <3> The RISC instruction equivalent to that before translation is executed. <4> To restore the data in the specific register zreg3, the data saved in the sp is read into zreg3 using the load (ldr) instruction.

For example, when the translation of a plurality of the CISC instructions with the memory operands into the RISC instructions are sequentially performed, the store instruction and the load instruction of <1> and <4> occur for each translation in order to save and restore the data, and thus the execution performance deteriorates.

In one aspect, an object is to improve the execution performance when the assembly code written in the CISC instruction with the memory operand is translated into the RISC instruction.

Hereinafter, embodiments of a translation program and a translation method will be described in detail with reference to the drawings. Note that the embodiments do not limit the present invention. Furthermore, each of the embodiments may be appropriately combined with each other within a range without inconsistency.

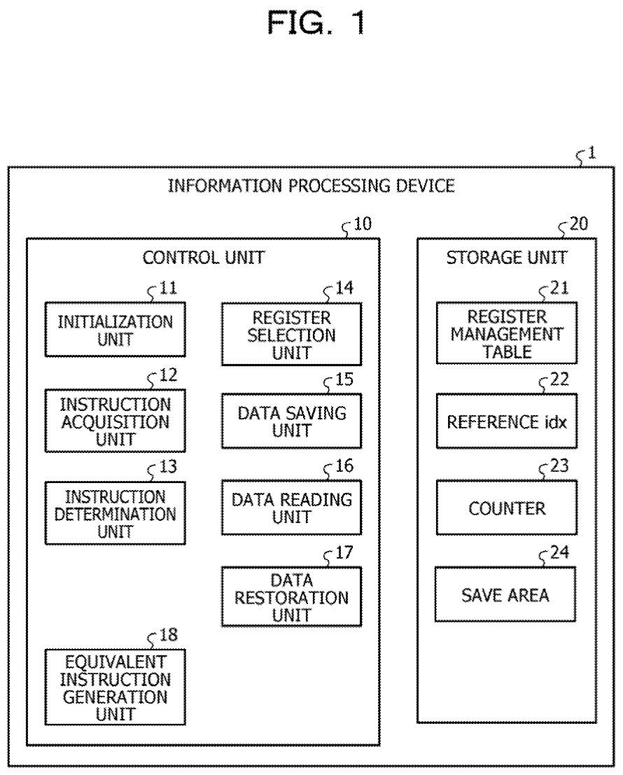

FIG. 1 is a block diagram illustrating an example of a functional configuration of an information processing device according to an embodiment. The information processing device 1 sequentially translates a plurality of CISC instructions with memory operands into RISC instructions. At this time, in a case where a register used for reading data of the memory operand in previous translation is not used in the instruction in this translation, the information processing device 1 skips data restoration and data saving for the register, and performs translation using the register. Note that, in the embodiment, the register used in the translation is a vector register but the vector register is an example and the embodiment is not limited to the example.

The information processing device 1 includes a control unit 10 and a storage unit 20. The control unit 10 is a processing unit that controls the entire information processing device 1, and includes an initialization unit 11, an instruction acquisition unit 12, an instruction determination unit 13, a register selection unit 14, a data saving unit 15, a data reading unit 16, and a data restoration unit 17, and an equivalent instruction generation unit 18. The storage unit 20 includes a register management table 21, a reference idx22, a counter 23, and a save area 24.

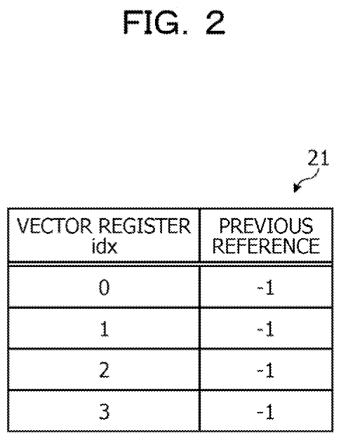

The register management table 21 is a management table in which a vector register idx is associated with timing of previously referencing (using) a register indicating the vector register idx. Here, an example of the register management table 21 will be described with reference to FIG. 2. FIG. 2 is a diagram illustrating an example of the register management table according to the embodiment. As illustrated in FIG. 2, the register management table 21 is information in which the vector register idx is associated with the previous reference. The vector register idx is an index that uniquely identifies the vector register. The index may be a number. The previous reference indicates previously referenced (used) timing. A value of the previous reference corresponds to a value of the counter 23 to be described below. As an example, “−1” is an initial value and indicates that the register is unused.

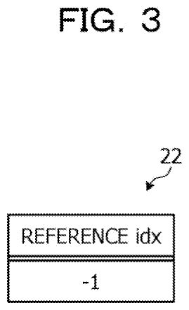

Returning to FIG. 1, the reference idx22 represents the vector register idx to be additionally used at the time of translation of an instruction with a memory operand. In a CISC, a plurality of processes can be performed with a single instruction, and not only a register but also a memory address can be specified as an operand. For example, in an assembly code for calculating “zmm0←zmm0+zmm1×ptr[r10]”, memory access is performed using a value of a register r10 as an address, and a value obtained by the memory access is multiplied by a value of a register zmm1, a value of a vector register zmm0 is added to the product, and a result is stored in a vector register zmm0. For example, the operands of the instruction are not limited to registers. In contrast, in an RISC, the operands of an instruction are limited to registers only. Therefore, when a CISC instruction with a memory operand is translated into an RISC instruction, an additional register to be used for translating the memory operand is needed. The vector register idx of this register is stored in the reference idx22. Here, an example of the reference idx22 will be described with reference to FIG. 3.

FIG. 3 is a diagram illustrating an example of the reference idx according to the embodiment. As illustrated in FIG. 3, the reference idx22 is idx of the vector register to be used to translate the memory operand. As an example, “−1” is an initial value and indicates that the register is unused.

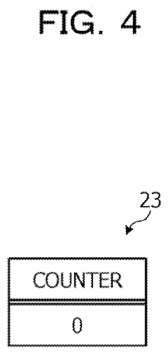

Returning to FIG. 1, the counter 23 is a counter that counts up each time the CISC instruction is translated. Here, an example of the counter 23 will be described with reference to FIG. 4.

FIG. 4 is a diagram illustrating an example of the counter according to the embodiment. As illustrated in FIG. 4, the counter 23 is incremented by 1 for each translation. As an example, “0” is an initial value and indicates that it has not been translated yet.

Returning to FIG. 1, the save area 24 is a save destination memory area in a case of saving the value stored in the vector register.

The initialization unit 11 initializes the register management table 21, the reference idx22, and the counter 23 used in the translation. For example, the initialization unit 11 sets the available vector register idx and sets the previous reference corresponding to the vector register idx to the initial value, for the register management table 21. The initialization unit 11 sets the initial value in the reference idx22. Then, the initialization unit 11 sets the initial value in the counter 23.

The instruction acquisition unit 12 acquires the CISC instruction to be translated into the RISC instruction. For example, the instruction acquisition unit 12 reads a target file. The instruction acquisition unit 12 sequentially acquires the CISC instructions to be translated from the read file.

The instruction determination unit 13 determines whether the acquired CISC instruction is an instruction with a memory operand. In the case where the acquired CISC instruction is an instruction with a memory operand, the instruction determination unit 13 transitions to the register selection unit 14 in order to process the instruction with a memory operand. Note that, in a case where the acquired CISC instruction is not an instruction with a memory operand, the instruction determination unit 13 may transition to the equivalent instruction generation unit 18.

The register selection unit 14 selects a vector register to be used for translation of the memory operand on the basis of the register management table 21. For example, the register selection unit 14 updates the previous reference in the register management table 21 with the value of the counter 23 for the vector register idx corresponding to the vector register to be used for translation. Then, in a case where the reference idx22 for storing the vector register idx to be used for translation of the memory operand is the initial value, the register selection unit 14 selects the vector register idx by a predetermined selection method using the register management table 21. Then, the register selection unit 14 updates the selected vector register idx to the reference idx22. Note that the register selection unit 14 does not select the vector register idx because the vector register idx has already been selected when the reference idx22 is not the initial value.

Here, the predetermined selection method will be described. The predetermined selection method may be selected as follows on the premise that the vector register idx that is not used for translation is selected from the vector registers idx in the register management table 21. For example, processing of the selection method selects the vector register idx with the previous reference indicating a minimum value. For example, the processing of the selection method preferentially uses an unused vector register idx, and selects the vector register idx translated at the oldest timing in a case where there is no unused vector register idx. In a case where there is a plurality of selection targets, the processing of the selection method may select the minimum vector register idx or the maximum vector register idx. Note that, in the embodiment, the processing of the selection method selects the vector register idx with the previous reference indicating the minimum value, but in a case where there is a plurality of minimum values, the minimum vector register idx is selected.

In the case where the vector register to be used for translation of the memory operand has been used before, the data saving unit 15 generates a store instruction for saving the data stored in the vector register. For example, the data saving unit 15 performs the following processing for the vector register idx selected by the register selection unit 14. For example, in a case where the value of the corresponding previous reference in the register management table 21 is a positive value, the corresponding register indicated by the vector register idx has been used before, so the data saving unit 15 generates the store instruction for saving the data stored in the corresponding register to the save area 24. Furthermore, in a case where the value of the previous reference in the register management table 21 is the initial value, the corresponding register indicated by the vector register idx has not been used before, so the data saving unit 15 does not generate the store instruction for saving the data stored in the corresponding register.

Thereby, the data saving unit 15 can reduce the number of times of issuance of a saving instruction by not saving the data when the vector register to be used for translation of the memory operand has not been used before even if the vector register is selected by the register selection unit 14.

The data reading unit 16 generates a load instruction for reading data into the vector register to be used for translation of the memory operand in order to translate the memory operand. For example, the data reading unit 16 generates a load instruction for reading data to be memory-accessed to the vector register indicated by the vector register idx stored in the reference idx22.

When translating a new CISC instruction with a memory operand, in the case where the vector register to be used for translation of the memory operand is used, the data restoration unit 17 generates a load instruction for restoring data in the vector register according to a predetermined condition. For example, in the case where the reference idx22 is not the initial value, the data restoration unit 17 determines whether the corresponding register of the vector register idx stored in the reference idx22 is to be used in the CISC instruction to be translated. Then, the data restoration unit 17 performs the following processing in the case where the corresponding register of the vector register idx stored in the reference idx22 is to be used in the CISC instruction to be translated. For example, in the case where the value of the previous reference in the register management table 21 is a positive value for the vector register idx stored in the reference idx22, the register has been used before, so the data restoration unit 17 generates the load instruction for restoring data for the corresponding register. Furthermore, in the case where the value of the previous reference in the register management table 21 is the initial value, the register has not been used before, so the data restoration unit 17 does not generate the load instruction for restoring data for the corresponding register.

Then, the data restoration unit 17 updates the reference idx22 to the initial value. The reference idx22 is updated to the initial value to cause the register selection unit 14 to newly select the vector register to be used for translation of the memory operand.

Thereby, the data restoration unit 17 can reduce the number of times of issuance of a restoration instruction by not restoring the data when the vector register to be used for translation of the memory operand has not been used before even if the vector register is used in an instruction when translating the new instruction.

Note that, in a case where the corresponding register of the vector register idx stored in the reference idx22 is not used in the CISC instruction to be translated, the data restoration unit 17 does not generate the load instruction for restoring data for the corresponding register. This is because the corresponding register of the vector register idx stored in the reference idx22 is reused for the translation of the new memory operand.

Thereby, the data restoration unit 17 can reduce the number of times of issuance of the restoration instruction by not restoring the data when the vector register to be used for translation of the memory operand is not used in an instruction when translating the new instruction.

The equivalent instruction generation unit 18 generates an RISC instruction equivalent to the CISC instruction. For example, the equivalent instruction generation unit 18 generates the RISC instruction equivalent to the CISC instruction using the vector register when the load instruction for reading data to the vector register to be used for translation of the memory operand is generated by the data reading unit 16. Then, the equivalent instruction generation unit 18 increments the counter 23 each time the CISC instruction is translated.

### Example of Translation Processing

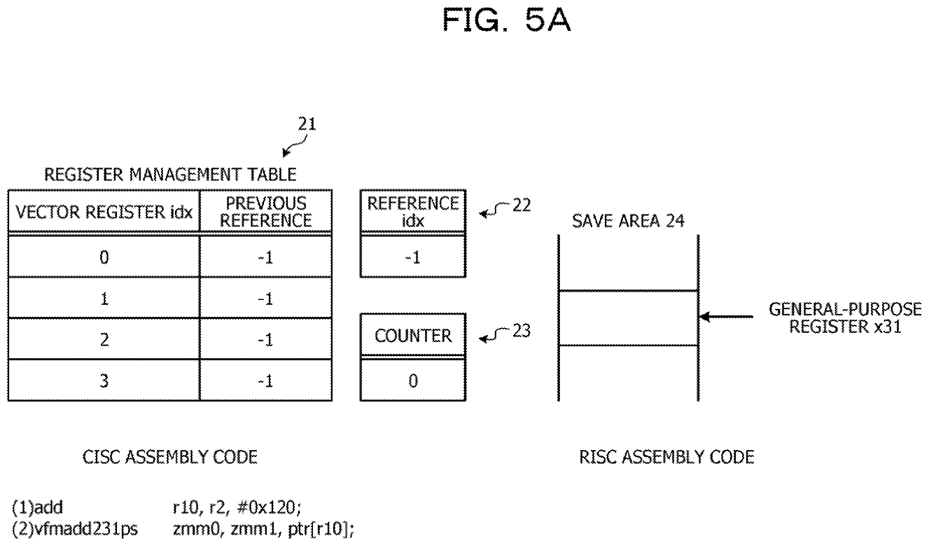

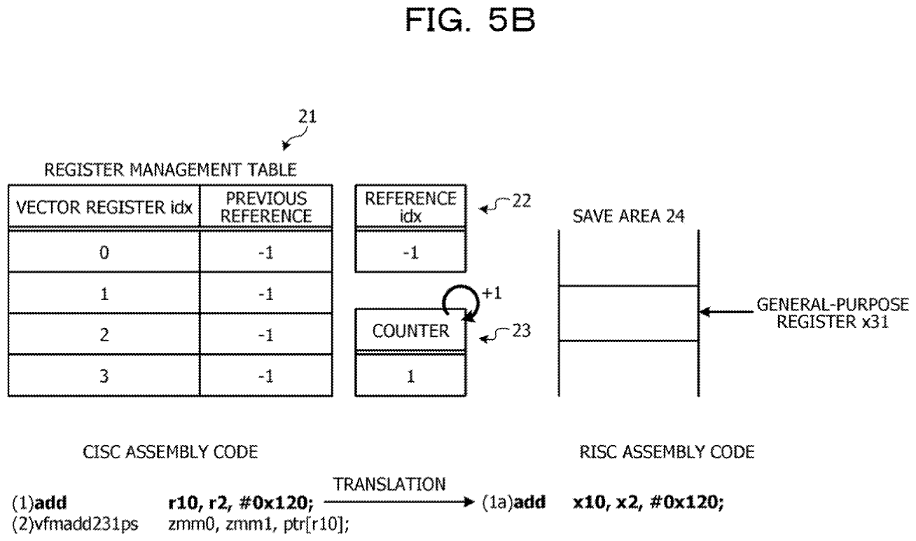

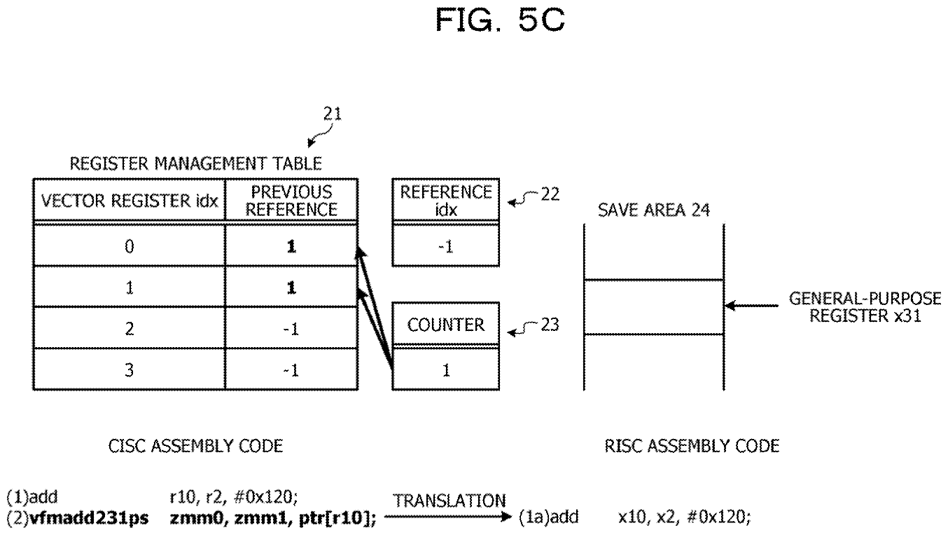

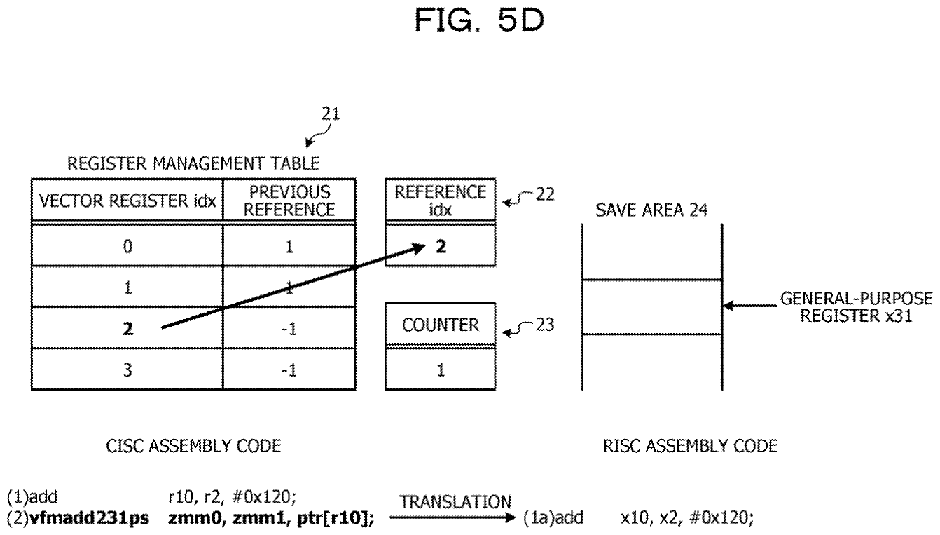

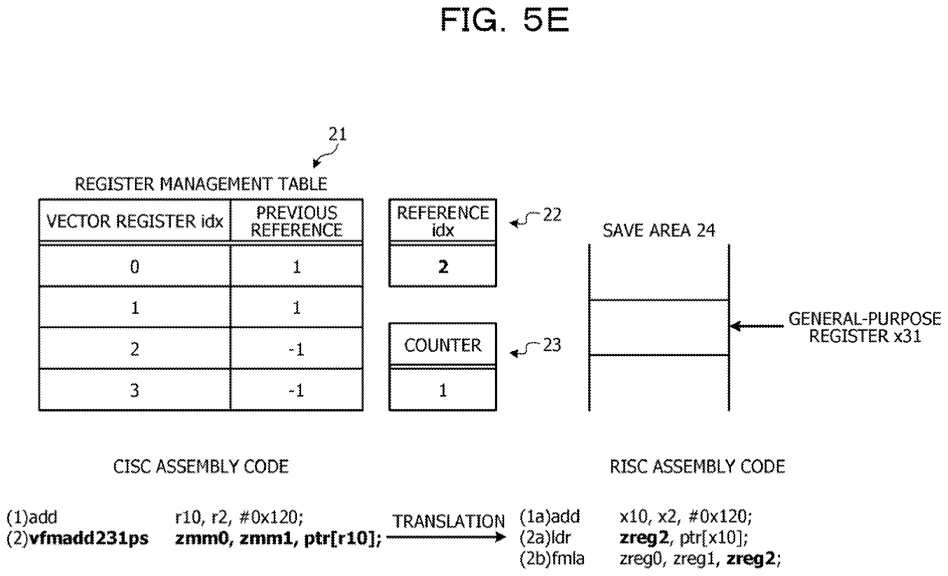

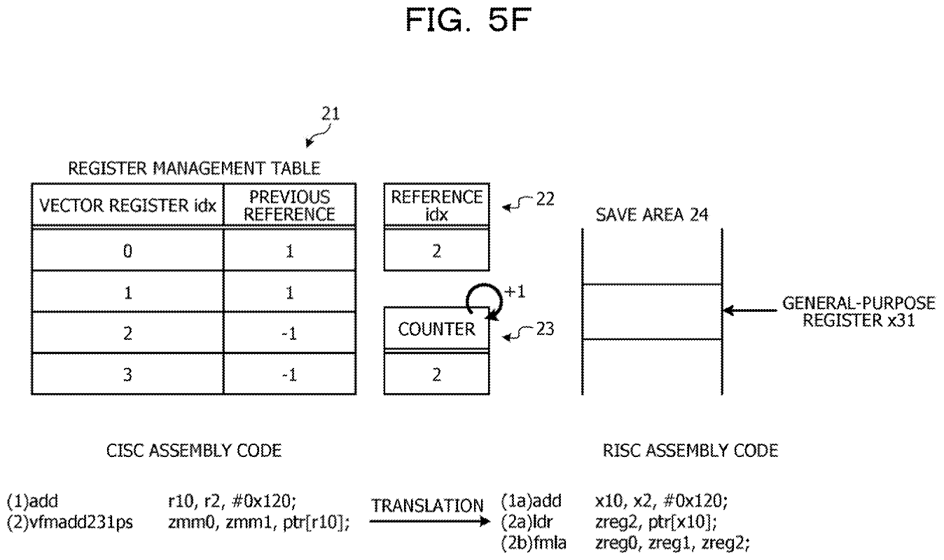

Here, an example of translation processing executed by the information processing device 1 will be described with reference to FIGS. 5A to 5F. FIGS. 5A to 5F are diagrams illustrating an example of the translation processing according to the embodiment. In FIGS. 5A to 5F, the translation processing in a case where a CISC assembly code is the following instructions (1) and (2) will be described. Note that r10 and r2 of the instructions (1) and (2) are 512-bit registers, and zmm0 and zmm1 are 512-bit vector registers. add

r10,r2,#0x120; (1)

vfmadd231ps zmm0,zmm1,ptr[r10]; (2)

Note that the instruction (1) is an addition instruction “r10←r2+0x120”. For example, the instruction (1) is an instruction for adding a constant 0x120 to the value of the register r2 and storing the value in the register r10. The instruction (2) is a multiplication/addition instruction “zmm0←zmm0+zmm1×ptr[r10]”. For example, the instruction (2) represents an instruction for performing memory access using the value of the register r10 as an address and reading 512 bits, multiplying 512 bits with the value of the vector register zmm1, adding a multiplication result to the value of the vector register zmm0, and storing the value in the zmm1. “ptr[r10]” in the instruction (2) is the memory operand.

As illustrated in FIG. 5A, the initialization unit 11 sets the available vector register idx and sets the previous reference corresponding to the vector register idx to the initial value, for the register management table 21. Here, 0 to 3 are set as the available vector registers idx in the register management table 21. Then, the initial value “−1” is set for all the previous references corresponding to the vector register idx. Furthermore, the initialization unit 11 sets the initial values in the reference idx22 and the counter 23. Here, the initial value “−1” is set for the reference idx22. The initial value “0” is set for the counter 23.

As illustrated in FIG. 5B, the instruction acquisition unit 12 acquires the instruction (1) as the assembly code for translation from the CISC to the RISC. The instruction determination unit 13 determines whether the instruction (1) is an instruction with a memory operand. Here, since the instruction (1) does not have a memory operand, the instruction (1) is determined not to be an instruction with a memory operand. Then, the equivalent instruction generation unit 18 generates the RISC instruction equivalent to the CISC instruction for the instruction (1). Here, the RISC assembly code is generated as in the following instruction (1a). For example, the instruction (1a) is an instruction for adding the constant 0x120 to the value of the register x2 and storing the value in the register x10.

add x10,x2,#0x120; (1a)

Then, the equivalent instruction generation unit 18 increments the counter 23. Here, the counter 23 is updated from 0 to 1.

As illustrated in FIG. 5C, the instruction acquisition unit 12 acquires the instruction (2) as the assembly code for translation from the CISC to the RISC. The instruction determination unit 13 determines whether the instruction (2) is an instruction with a memory operand. Here, since the instruction (2) has the memory operand “ptr[r10]”, the instruction (2) is determined to be an instruction with a memory operand.

Furthermore, the register selection unit 14 updates the previous reference in the register management table 21 with the value of the counter 23 for the vector register idx corresponding to the vector register to be used for translation. Here, in the instruction (2), the vector registers to be used for translation are zmm0 and zmm1. Therefore, the register selection unit 14 updates the previous reference in the register management table 21 with the value “1” of the counter 23 for the vector register idx “0” corresponding to zmm0 and the vector register idx “1” corresponding to zmm1.

As illustrated in FIG. 5D, in the case where the reference idx22 is “−1” indicating the initial value, the register selection unit 14 selects the vector register idx by a predetermined selection method and updates the selected vector register idx to the reference idx22, using the register management table 21. Here, the selection method is a case of selecting the vector register idx with the previous reference indicating the minimum value, but selecting the minimum vector register idx in the case where there is a plurality of minimum values. Therefore, the vector register idx “2” having the previous reference indicating the minimum value “−1” is selected, and the reference idx22 is updated to “2”.

As illustrated in FIG. 5E, in the case where the value of the previous reference in the register management table 21 is a positive value for the selected vector register idx, the data saving unit 15 generates the store instruction for saving the data stored in the vector register of the vector register idx. Here, for the selected vector register idx “2”, the value of the previous reference in the register management table 21 is “−1” indicating the initial value, and is not a positive value. Therefore, the data saving unit 15 does not generate the store instruction for saving the data stored in the vector register of the vector register idx “2”. Thereby, the data saving unit 15 can reduce the number of times of issuance of the saving instruction by not saving the data when the vector register to be used for translation of the memory operand has not been used before even if the vector register is selected by the register selection unit 14.

Then, the data reading unit 16 generates a load instruction for reading data to be memory-accessed to the vector register indicated by the vector register idx “2” stored in the reference idx22. Here, the RISC assembly code is generated as in the following instruction (2a). Note that zreg2 of the instruction (2a) is a vector register indicated by the vector register idx “2”, and is a 512-bit vector register. ptr[x10] is data obtained by performing memory access using the value of the register x10 as the address and reading 512 bits. In the instruction (2a), this data read by the memory access is loaded into the vector register zreg2.

ldr zreg2,ptr[x10]; (2a)

Then, the equivalent instruction generation unit 18 generates the RISC instruction equivalent to the CISC instruction for the instruction (2). Here, the RISC assembly code is generated as in the following instruction (2b). For example, the instruction (2b) is an instruction for multiplying the value of the vector register zreg2 of the instruction (2a) with the value of the vector register zreg1, adding a multiplication result to the value of the vector zreg0, and storing the value in the zreg0.

fmla zreg0,zreg1,zreg2; (2b)

As illustrated in FIG. 5F, the equivalent instruction generation unit 18 increments the counter 23. Here, the counter 23 is updated from 1 to 2.

In this way, the information processing device 1 can reduce the number of times of saving data that occurs when translating the CISC instruction with a memory operand into the RISC instruction, using the register management table 21, the reference idx22, and the counter 23.

### Another Example of Translation Processing

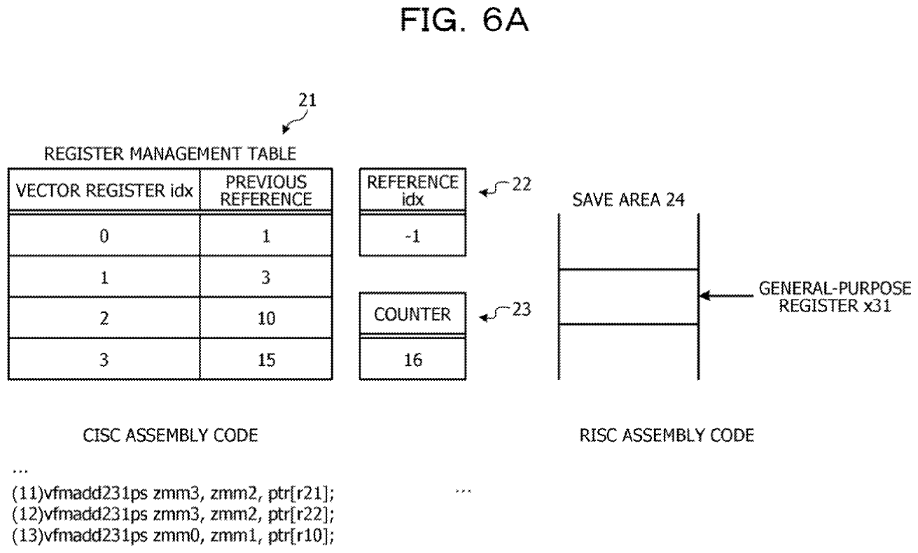

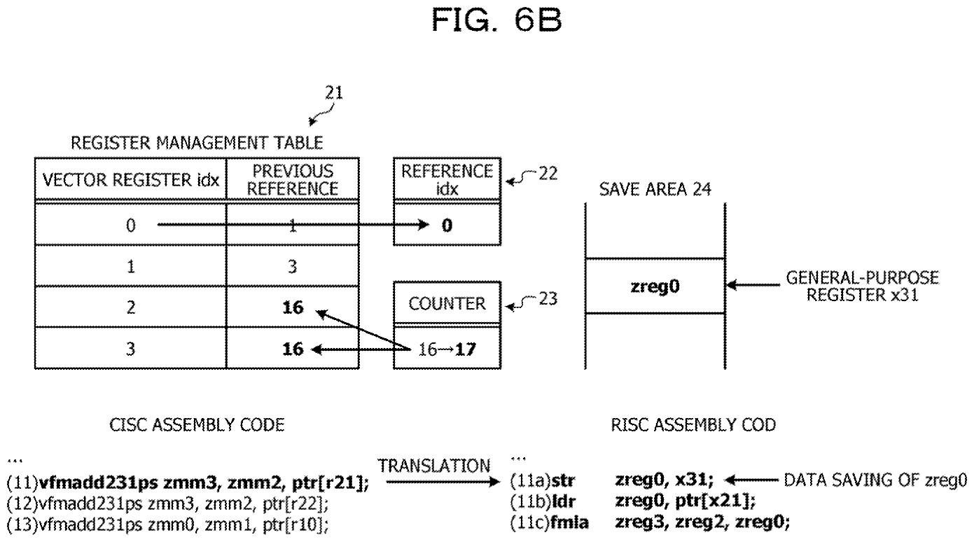

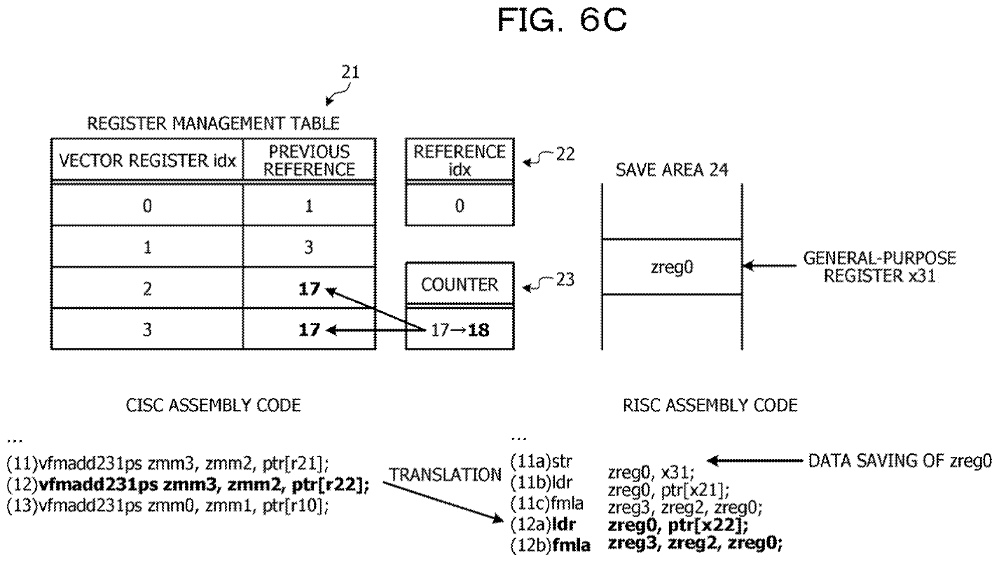

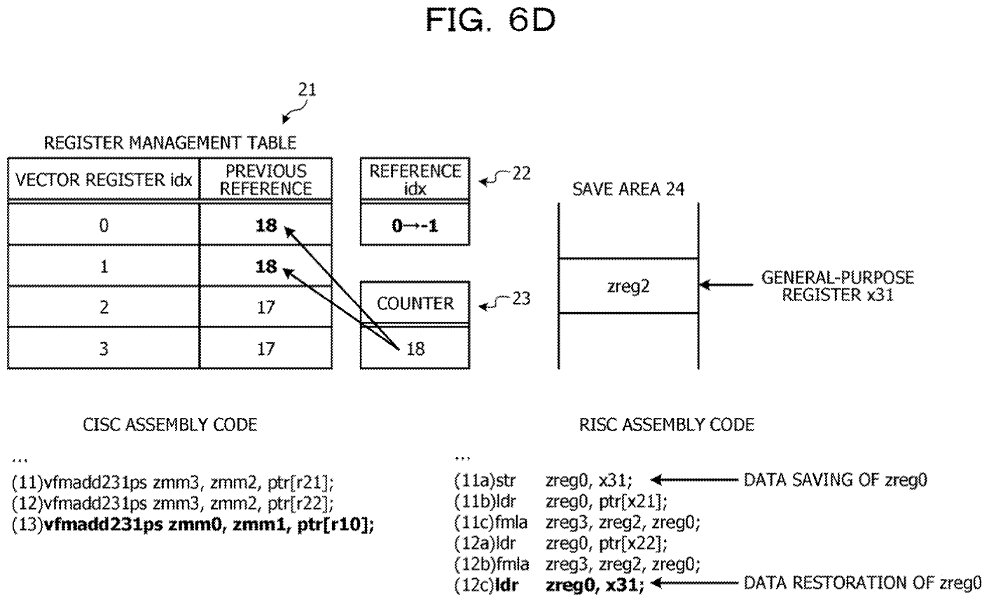

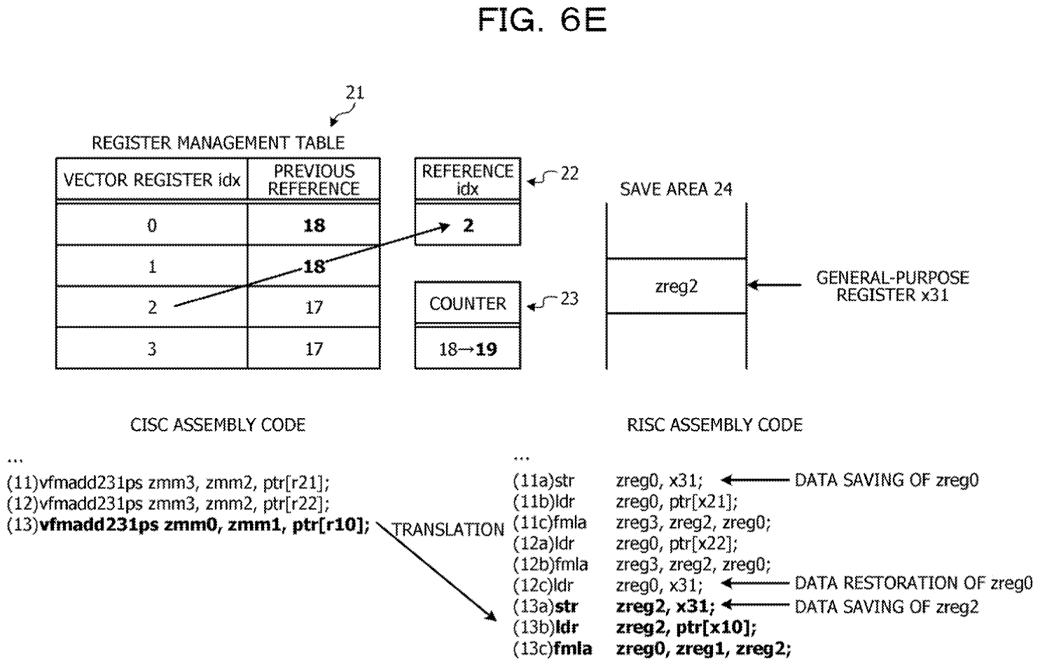

Next, another example of the translation processing executed by the information processing device 1 will be described with reference to FIGS. 6A to 6E. FIGS. 6A to 6E are diagrams illustrating another example of the translation processing according to the embodiment. In FIGS. 6A to 6E, the translation processing in a case where the CISC assembly code is the following instructions (11), (12), and (13) will be described. Note that r10, r21, and r22 of the instructions (11), (12), and (13) are 512-bit registers, and zmm0, zmm1, zmm2, and zmm3 are 512-bit vector registers.

vfmadd231ps zmm3,zmm2,ptr[r21]; (11)

vfmadd231ps zmm3,zmm2,ptr[r22]; (12)

vfmadd231ps zmm0,zmm1,ptr[r10]; (13)

Note that the instructions (11), (12), and (13) have different registers respectively but they have the same function as the instruction (2), so description of the content of the instructions is omitted.

As illustrated in FIG. 6A, 0 to 3 are set as the available vector registers idx in the register management table 21. Then, “1” is set in the previous reference corresponding to the vector register idx “0”. “3” is set in the previous reference corresponding to the vector register idx “1”. “10” is set in the previous reference corresponding to the vector register idx “2”. “15” is set in the previous reference corresponding to the vector register idx “3”. Then, the initial value “−1” is set in the reference idx22 that stores the vector register idx to be used for translation of the memory operand. “16” is set in the counter 23.

As illustrated in FIG. 6B, the instruction acquisition unit 12 acquires the instruction (11) as the assembly code for translation from the CISC to the RISC. The instruction determination unit 13 determines whether the instruction (11) is an instruction with a memory operand. Here, since the instruction (11) has the memory operand “ptr[r21]”, the instruction (11) is determined to be an instruction with a memory operand.

Furthermore, the register selection unit 14 updates the previous reference in the register management table 21 with the value of the counter 23 for the vector register idx corresponding to the vector register to be used for translation. Here, in the instruction (11), the vector registers used for translation are zmm3 and zmm2. Therefore, the register selection unit 14 updates the previous reference in the register management table 21 with the value “16” of the counter 23 for the vector register idx “3” corresponding to zmm3 and the vector register idx “2” corresponding to zmm2.

Then, in the case where the reference idx22 is “−1” indicating the initial value, the register selection unit 14 selects the vector register idx by a predetermined selection method and updates the selected vector register idx to the reference idx22, using the register management table 21. Here, since the reference idx22 is “−1” indicating the initial value, the vector register idx is selected. The selection method is the case of selecting the vector register idx with the previous reference indicating the minimum value, but selecting the minimum vector register idx in the case where there is a plurality of minimum values. Therefore, the vector register idx “0” having the previous reference indicating the minimum value “1” is selected, and the reference idx22 is updated to “0”.

Then, in the case where the value of the previous reference in the register management table 21 is a positive value for the selected vector register idx, the register has been used before, so the data saving unit 15 generates the store instruction for saving the data stored in the corresponding register of the vector register idx. Here, for the selected vector register idx “0”, the value of the previous reference in the register management table 21 is “1”, which is a positive value. Therefore, the data saving unit 15 generates the store instruction for saving the data stored in the vector register of the vector register idx “0”. Here, the RISC assembly code is generated as in the following instruction (11a). Note that zreg0 of the instruction (11a) is a vector register indicated by the vector register idx “0”, and is a 512-bit vector register. In the instruction (11a), the data stored in zreg0 is saved in the save area 24 using the value of a general-purpose register x31 as an address.

str zreg0,x31; (11a)

Then, the data reading unit 16 generates a load instruction for reading data to be memory-accessed to the vector register indicated by the vector register idx “0” stored in the reference idx22. Here, the RISC assembly code is generated as in the following instruction (11b). Note that zreg0 of the instruction (11b) is a vector register indicated by the vector register idx “0”, and is a 512-bit vector register. ptr[x21] is data obtained by performing memory access using the value of the register x21 as the address and reading 512 bits. In the instruction (11b), the data read by the memory access is loaded into the vector register zreg0.

ldr zreg0,ptr[x21]; (11b)

Then, the equivalent instruction generation unit 18 generates the RISC instruction equivalent to the CISC instruction for the instruction (11). Here, the RISC assembly code is generated as in the following instruction (11c). For example, the instruction (11c) is an instruction for multiplying the value of the vector register zreg0 of the instruction (11b) with the value of the vector register zreg2, adding a multiplication result to the value of the vector zreg3, and storing the value in the zreg3.

fmla zreg3,zreg2,zreg0; (11c)

Then, the equivalent instruction generation unit 18 increments the counter 23. Here, the counter 23 is updated from 16 to 17.

As illustrated in FIG. 6C, the instruction acquisition unit 12 acquires the instruction (12) as the assembly code for translation from the CISC to the

RISC. The instruction determination unit 13 determines whether the instruction (12) is an instruction with a memory operand. Here, since the instruction (12) has the memory operand “ptr[r22]”, the instruction (12) is determined to be an instruction with a memory operand.

Furthermore, in the case where the reference idx22 is not the initial value, the data restoration unit 17 determines whether the corresponding register of the vector register idx stored in the reference idx22 is to be used in the CISC instruction to be translated. The data restoration unit 17 performs the following processing in the case where the corresponding register of the vector register idx stored in the reference idx22 is to be used in the CISC instruction to be translated. In the case where the value of the previous reference in the register management table 21 is a positive value for the vector register idx stored in the reference idx22, the data restoration unit 17 generates the load instruction for restoring data to the corresponding register. Here, the reference idx22 is “0”, so it is not the initial value. In addition, the vector register of the vector register idx “0” indicated by reference idx22 is not used in the instruction (12). Therefore, in such a case, the data restoration unit 17 does not generate the load instruction for restoring data to the corresponding register. Thereby, the data restoration unit 17 can reduce the number of times of issuance of the restoration instruction by not restoring the data even if the vector register to be used for translation of the memory operand has already been used but the vector register is not used in a new instruction when translating the new instruction.

Then, the register selection unit 14 updates the previous reference in the register management table 21 with the value of the counter 23 for the vector register idx corresponding to the vector register to be used for translation. Here, in the instruction (12), the vector registers to be used for translation are zmm3 and zmm2. Therefore, the register selection unit 14 updates the previous reference in the register management table 21 with the value “17” of the counter 23 for the vector register idx “3” corresponding to zmm3 and the vector register idx “2” corresponding to zmm2.

Then, since the reference idx22 is not the initial value, the register selection unit 14 skips saving of the data of the vector register in the vector register idx “0” stored in the reference idx22, and proceeds to the next data reading processing. Thereby, the data saving unit 15 can reduce the number of times of issuance of a saving instruction by not saving the data when the vector register is not used in the instruction of this time if the vector register (here, “0”) to be used for translation of the memory operand has already been selected.

Then, the data reading unit 16 generates a load instruction for reading data to be memory-accessed to the vector register indicated by the vector register idx “0” stored in the reference idx22.

ldr zreg0,ptr[x22]; (12a)

Then, the equivalent instruction generation unit 18 generates the RISC instruction equivalent to the CISC instruction for the instruction (12). Here, the RISC assembly code is generated as in the following instruction (12b). For example, the instruction (12b) is an instruction for multiplying the value of the vector register zreg0 of the instruction (12a) with the value of the vector register zreg2, adding a multiplication result to the value of the vector zreg3, and storing the value in the zreg3.

fmla zreg3,zreg2,zreg0; (12b)

Then, the equivalent instruction generation unit 18 increments the counter 23. Here, the counter 23 is updated from 17 to 18.

As illustrated in FIG. 6D, the instruction acquisition unit 12 acquires the instruction (13) as the assembly code for translation from the CISC to the RISC. The instruction determination unit 13 determines whether the instruction (13) is an instruction with a memory operand. Here, since the instruction (13) has the memory operand ptr[r10], the instruction (13) is determined to be an instruction with a memory operand.

When translating a new CISC instruction with a memory operand, in the case where the vector register to be used for translation of the memory operand is used, the data restoration unit 17 generates a load instruction for restoring data in the vector register according to a predetermined condition. For example, in the case where the reference idx22 is not the initial value, the data restoration unit 17 determines whether the corresponding register of the vector register idx stored in the reference idx22 is to be used in the CISC instruction to be translated. Then, the data restoration unit 17 performs the following processing in the case where the corresponding register of the vector register idx stored in the reference idx22 is to be used in the CISC instruction to be translated. For example, in the case where the value of the previous reference in the register management table 21 is a positive value for the vector register idx stored in the reference idx22, the data restoration unit 17 generates the load instruction for restoring data for the corresponding register. Here, the reference idx22 is “0”, so it is not the initial value. However, the vector register of the vector register idx “0” indicated by the reference idx22 is used in the instruction (13). The vector register used is “zmm0”. Therefore, in such a case, the data restoration unit 17 generates the load instruction for restoring data for the corresponding register of the vector register idx “0”. The load instruction to be generated is generated as in the following instruction (12c). Note that zreg0 of the instruction (12c) is a vector register indicated by the vector register idx “0”, and is a 512-bit vector register. x31 is a general-purpose register in the save area. In the instruction (12c), the data saved in the save area 24 indicated by the address, where the value of the general-purpose register x31 is the address, is restored to zreg0.

ldr zreg0,x31; (12c)

Then, the data restoration unit 17 updates the reference idx22 to the initial value. Here, the reference idx22 is updated from “0” to “−1” indicating the initial value.

Then, the register selection unit 14 updates the previous reference in the register management table 21 with the value of the counter 23 for the vector register idx corresponding to the vector register to be used for translation. Here, in the instruction (13), the vector registers to be used for translation are zmm0 and zmm1. Therefore, the register selection unit 14 updates the previous reference in the register management table 21 with the value “18” of the counter 23 for the vector register idx “1” corresponding to zmm0 and the vector register idx “3” corresponding to zmm1.

Subsequently, in FIG. 6E, in the case where the reference idx22 is “−1” indicating the initial value, the register selection unit 14 selects the vector register idx by a predetermined selection method and updates the selected vector register idx to the reference idx22, using the register management table 21. Here, since the reference idx22 is “−1” indicating the initial value, “2” is selected for the vector register idx on the basis of a predetermined selection method, and the reference idx22 is updated to “2”.

Then, in the case where the value of the previous reference in the register management table 21 is a positive value for the selected vector register idx, the register has been used before, so the data saving unit 15 generates the store instruction for saving the data stored in the corresponding register of the vector register idx. Here, for the selected vector register idx “2”, the value of the previous reference in the register management table 21 is “17”, which is a positive value. Therefore, the data saving unit 15 generates the store instruction for saving the data stored in the vector register of the vector register idx “2”. Here, the RISC assembly code is generated as in the following instruction (13a). Note that zreg2 of the instruction (13a) is a vector register indicated by the vector register idx “2”, and is a 512-bit vector register. In the instruction (13a), the data stored in zreg2 is saved in the save area 24 using the value of the general-purpose register x31 as an address.

str zreg2,x31; (13a)

Then, the data reading unit 16 generates a load instruction for reading data to be memory-accessed to the vector register indicated by the vector register idx “2” stored in the reference idx22. Here, the RISC assembly code is generated as in the following instruction (13b). Note that zreg2 of the instruction (13b) is a vector register indicated by the vector register idx “2”, and is a 512-bit vector register. ptr[x10] is data obtained by performing memory access using the value of the register x10 as the address and reading 512 bits. In instruction (13b), the data read by the memory access is loaded into the vector register zreg2.

ldr zreg2,ptr[x10]; (13b)

Then, the equivalent instruction generation unit 18 generates the RISC instruction equivalent to the CISC instruction for the instruction (13). Here, the RISC assembly code is generated as in the following instruction (13c). For example, the instruction (13c) is an instruction for multiplying the value of the vector register zreg2 of the instruction (13b) with the value of the vector register zreg1, adding a multiplication result to the value of the vector zreg0, and storing the value in the zreg0.

fmla zreg0,zreg1,zreg2; (13c)

Then, the equivalent instruction generation unit 18 increments the counter 23. Here, the counter 23 is updated from 18 to 19.

In this way, the information processing device 1 can reduce the number of times of saving and restoration of data that occurs when translating the CISC instruction with a memory operand into the RISC instruction, using the register management table 21, the reference idx22, and the counter 23.

### Flowchart of Translation Processing

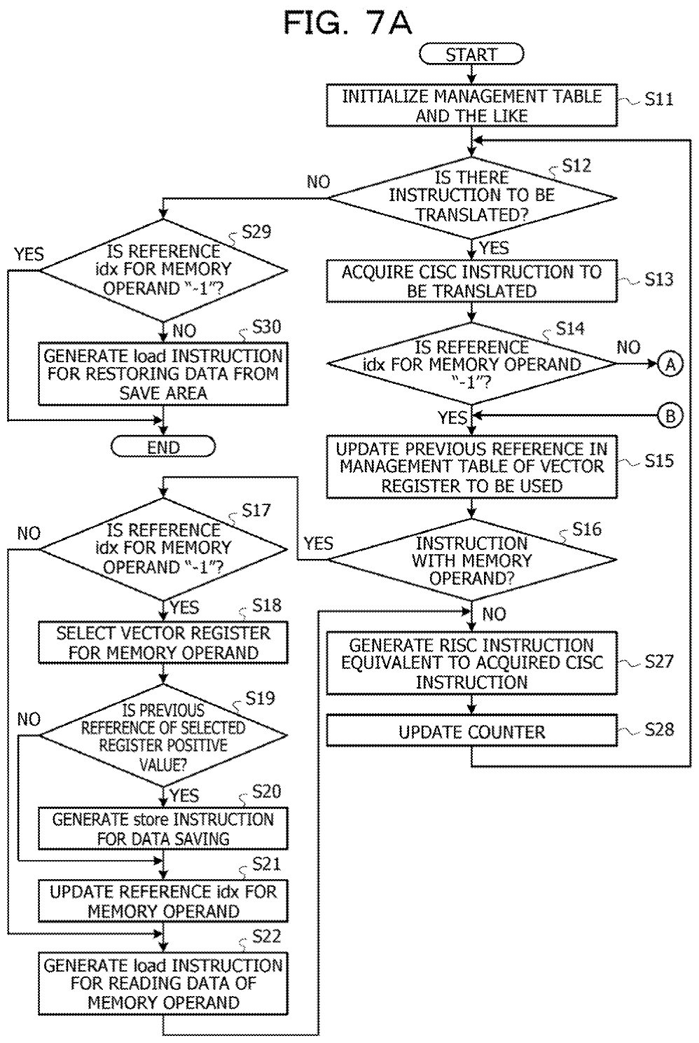

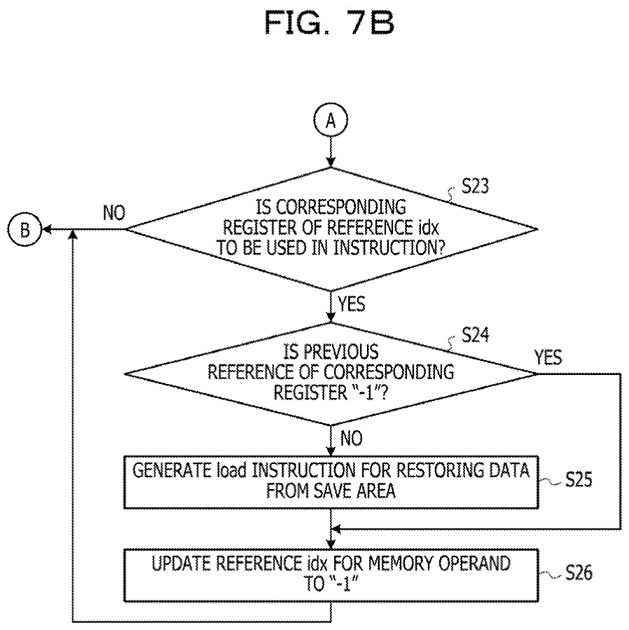

FIGS. 7A and 7B are a diagram illustrating an example of a flowchart of the translation processing according to the embodiment. As illustrated in FIGS. 7A and 7B, the information processing device 1 initializes the register management table 21 and the like (step S11). For example, the initialization unit 11 sets the available vector register idx and sets “−1” as the initial value in the previous reference corresponding to the vector register idx, for the register management table 21. The initialization unit 11 sets “−1” as the initial value in the reference idx22. Then, the initialization unit 11 sets “0” as the initial value in the counter 23.

The information processing device 1 determines whether there is an instruction for translation from the CISC to the RISC (step S12). In a case of determining that there is the instruction for translation (step S12; Yes), the information processing device 1 acquires the CISC instruction to be translated (step S13). Then, the information processing device 1 determines whether the reference idx22 for the memory operand is “−1” indicating the initial value (step S14).

In a case of determining that the reference idx22 for the memory operand is “−1” (step S14; Yes), the information processing device 1 updates the previous reference in the register management table 21 for the vector register to be used for translation (step S15). For example, the register selection unit 14 updates the previous reference in the register management table 21 with the value of the counter 23 for the vector register idx corresponding to the vector register to be used for translation.

Then, the information processing device 1 determines whether the CISC instruction to be translated is an instruction with a memory operand (step S16). In a case of determining that the CISC instruction to be translated is not an instruction with a memory operand (step S16; No), the information processing device 1 proceeds to step S27 in order to translate the CISC instruction as it is.

On the other hand, in a case of determining that the CISC instruction to be translated is an instruction with a memory operand (step S16; Yes), the information processing device 1 determines whether the reference idx22 for the memory operand is “−1” indicating the initial value (step S17). In a case of determining that the reference idx22 for the memory operand is not “−1” (step S17; No), the information processing device 1 proceeds to step S22 without saving the data of the vector register indicated by the reference idx22.

On the other hand, in a case of determining that the reference idx22 for the memory operand is “−1” (step S17; Yes), the information processing device 1 selects the vector register for the memory operand (step S18). For example, the register selection unit 14 selects the vector register idx by a predetermined selection method using the register management table 21.

Then, the information processing device 1 determines whether the previous reference of the selected vector register is a positive value (step S19). For example, the data saving unit 15 determines whether the value of the previous reference in the register management table 21 is a positive value for the selected vector register idx.

In a case of determining that the previous reference of the selected vector register is a positive value (step S19; Yes), the information processing device 1 generates the store instruction for saving data for the selected vector register (step S20). For example, in the case where the value of the previous reference in the register management table 21 is a positive value, the data saving unit 15 generates the store instruction for saving the data stored in the vector register indicated by the selected vector register idx to the save area 24. Then, the information processing device 1 proceeds to step S21.

On the other hand, in a case of determining that the previous reference of the selected vector register is not a positive value (step S19; No), the information processing device 1 proceeds to step S21 without saving data of the selected vector register.

In step S21, the information processing device 1 updates the reference idx22 for the memory operand (step S21). For example, the register selection unit 14 updates the selected vector register idx to the reference idx22. Then, the information processing device 1 proceeds to step S22.

In step S22, the information processing device 1 generates the load instruction for reading data of the memory operand (step S22). For example, the data reading unit 16 generates the load instruction for reading data to be memory-accessed to the vector register indicated by the vector register idx stored in the reference idx22. Then, the information processing device 1 proceeds to step S27 in order to translate the CISC instruction.

In the case of determining that the reference idx22 for the memory operand is not “−1” (step S14; No) in step S14, the information processing device 1 determines whether the corresponding register of the reference idx22 is used in the instruction (step S23). For example, in the case where the reference idx22 is not the initial value, the data restoration unit 17 determines whether the corresponding register of the vector register idx stored in the reference idx22 is to be used in the CISC instruction to be translated.

In a case of determining that the corresponding register of the reference idx22 is not used in the instruction (step S23; No), the information processing device 1 proceeds to step S15 without restoring the data in the vector register indicated by the reference idx22.

On the other hand, in a case of determining that the corresponding register of the reference idx22 is used in the instruction (step S23; Yes), the information processing device 1 determines whether the previous reference of the corresponding register is “−1” as the initial value (step S24). For example, the data restoration unit 17 determines whether the value of the previous reference in the register management table 21 is the initial value for the vector register idx stored in the reference idx22.

In a case of determining that the previous reference of the corresponding register is “−1” indicating the initial value (step S24; Yes), the information processing device 1 proceeds to step S26 in order to update the previous reference of the vector register to be used. Here, the information processing device 1 does not restore the data to the vector register indicated by the reference idx22.

On the other hand, in a case of determining that the previous reference of the corresponding register is not “−1” indicating the initial value (step S24; No), the information processing device 1 generates the load instruction for restoring data from the save area 24 (step S25). For example, in the case where the value of the previous reference in the register management table 21 is a positive value for the vector register idx stored in the reference idx22, the data restoration unit 17 generates the load instruction for restoring data for the corresponding register. Then, the information processing device 1 proceeds to step S26.

In step S26, the information processing device 1 updates the reference idx22 for the memory operand to “−1” indicating the initial value (step S26). Then, the information processing device 1 proceeds to step S15 in order to update the previous reference of the vector register to be used.

In step S27, the information processing device 1 generates an RISC instruction equivalent to the acquired CISC instruction (step S27). For example, the equivalent instruction generation unit 18 generates the RISC instruction equivalent to the CISC instruction using the vector register when the load instruction for reading data to the vector register to be used for translation of the memory operand is generated.

Then, the information processing device 1 updates the counter 23 (step S28). For example, the equivalent instruction generation unit 18 increments the counter 23 each time the CISC instruction is translated. Then, the information processing device 1 proceeds to step S12 in order to acquire the next instruction for translation.

In a case of determining that there is no instruction to be translated in step S12 (step S12; No), the information processing device 1 determines whether the reference idx22 for the memory operand is “−1” indicating the initial value (step S29). In a case of determining that the reference idx22 for the memory operand is “−1” (step S29; Yes), the information processing device 1 terminates the translation processing.

On the other hand, in a case of determining that the reference idx22 for the memory operand is not “−1” (step S29; No), the information processing device 1 generates the load instruction for restoring data from the save area 24 (step S30). For example, the data restoration unit 17 generates the load instruction for restoring data to the corresponding register for the vector register idx stored in the reference idx22. Then, the information processing device 1 terminates the translation processing.

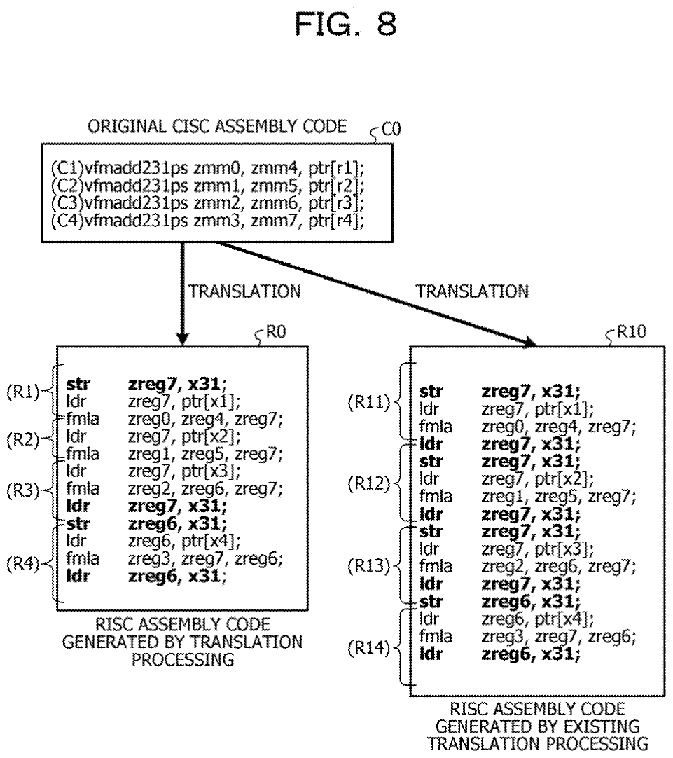

Here, an example of effects of the translation processing according to the embodiment will be described with reference to FIG. 8. FIG. 8 is a diagram for describing an example of effects of the translation processing according to the embodiment. As illustrated in FIG. 8, the original CISC assembly code C0 is illustrated. In the CISC assembly code, four instructions (21), (22), (23), and (24) are described, and each instruction is an instruction with a memory operand.

When the original CISC assembly code C0 is translated by existing translation processing, the translation result becomes an assembly code represented by reference numeral R10. For example, the CISC instruction of (C1) is translated into the RISC instruction of (R11). The CISC instruction of (C2) is translated into the RISC instruction of (R12). The CISC instruction of (C3) is translated into the RISC instruction of (R13). The CISC instruction of (C4) is translated into the RISC instruction of (R14). Here, in existing translation processing, a str instruction for saving data in a register for a memory operand and an ldr instruction for restoring data are added before and after an fmla instruction equivalent to all vfmadd231ps instructions. For example, the str instruction for saving data in the register zreg7 for the memory operand is added before the fmla instruction in (R11), and the ldr instruction for restoring the data in the register zreg7 for the memory operand is added after the fmla instruction in (R11). The instructions are similarly added to (R12), (R13) and (R14).

In contrast, when the original CISC assembly code C0 is translated by the translation processing according to the embodiment, the translation result becomes an assembly code represented by reference numeral R0. For example, the CISC instruction of (C1) is translated into the RISC instruction of (R1). The CISC instruction of (C2) is translated into the RISC instruction of (R2). The CISC instruction of (C3) is translated into the RISC instruction of (R3). The CISC instruction of (C4) is translated into the RISC instruction of (R4). Here, in the translation processing according to the embodiment, the processing is performed as follows.

In the translation processing of (C1), the str instruction for saving data in the register zreg7 for the memory operand is added before the fmla instruction of (R1) equivalent to the vfmadd231ps instruction. However, since the register zreg7 for the memory operand is not used in the instruction of the next translation processing (C2), the ldr instruction (ldr zreg7, x31) for restoring data in zreg7 after the fmla instruction is not added.

In the translation processing of (C2), since the register zreg7 for the memory operand has already been used, the str instruction (str zreg7, x31) for saving data is not added before the fmla instruction (R2) equivalent to the vfmadd231ps instruction. In addition, since the register zreg7 for the memory operand is not used in the instruction of the next translation processing (C3), the ldr instruction (ldr zreg7, x31) for restoring data in zreg7 after the fmla instruction is not added.

In the translation processing of (C3), since the register zreg7 for the memory operand has already been used, the str instruction (str zreg7, x31) for saving data is not added before the fmla instruction (R3) equivalent to the vfmadd231ps instruction. However, since the register zreg7 for the memory operand is used in the instruction of the next translation processing (C4), the ldr instruction (ldr zreg7, x31) for restoring data in zreg7 after the fmla instruction is added.

Then, in the translation processing of (C4), the register for the memory operand is not selected. Therefore, the str instruction for saving data in zreg6, which is newly selected as the register for the memory operand, is added before the (R4) fmla instruction equivalent to the vfmadd231ps instruction. Then, since there is no instruction for the next translation processing, the ldr instruction (ldr zreg7, x31) for storing data in zreg6 after the fmla instruction is added after the fmla instruction.

As described above, the translation processing according to the embodiment can reduce the data save instruction and the data restoration instruction that are additionally generated.

### Effects of Embodiment

According to the above-described embodiment, the information processing device 1 increments the counter 23 each time translating the CISC instruction into the RISC instruction. The information processing device 1 updates the previously referenced translation timing of the register to be used for translation with the value of the counter 23 when translating the CISC instruction with a memory operand into the RISC instruction. In the case where the use register number that stores the register number to be used for translation of the memory operand is the initial value, the information processing device 1 selects the register number by a predetermined selection method and updates the use register number to the selected register number, using the register management table 21 in which the register number and the previously referenced translation timing are associated with each other. In the case where the use register number is not the initial value, and when the use register number is not used in the translation into the RISC instruction, the information processing device 1 skips data restoration and data saving for the register indicated by the use register number, and generates an instruction for reading data of the memory operand using the register indicated by the use register number. Then, the information processing device 1 generates the RISC instruction equivalent to the CISC instruction. According to such a configuration, the information processing device 1 may improve an execution speed by reducing the instructions of data restoration (load) and data saving (store) of the register to be used for reading data of the memory operand by using the use status of the register.

Furthermore, according to the above-described embodiment, in the case where the use register number is not the initial value, and in the case where the use register number is used in the translation into the RISC instruction, when the previously referenced translation timing associated with the use register number in the register management table 21 does not exist, the information processing device 1 skips the data restoration for the register indicated by the use register number, and sets the use register number to the initial value. Then, the information processing device 1 executes the update processing for the use register number. According to such a configuration, the information processing device 1 may reduce the instruction of the data restoration (load) of the register indicated by the use register number and may improve the execution speed by using the previously referenced translation timing associated with the use register number.

Furthermore, according to the above-described embodiment, in the case where the use register number is not the initial value, and in the case where the use register number is used in the translation into the RISC instruction, when the previously referenced translation timing associated with the use register number in the register management table 21 exists, the information processing device 1 restores the data for the register indicated by the use register number, and sets the use register number to the initial value. Then, the information processing device 1 executes the update processing for the use register number. With such a configuration, the information processing device 1 may grasp the execution timing of the update processing for the use register number by using the initial value set for the use register number.

Furthermore, according to the above-described embodiment, when the previously referenced translation timing associated with the selected register number does not exist, the information processing device 1 skips saving of data for the register indicated by the selected register number, and updating the use register number to the selected register number, using the register management table 21. According to such a configuration, the information processing device 1 may reduce the instruction of the data saving (store) for the register indicated by the selected register number and may improve the execution speed by using the previously referenced translation timing associated with the selected register number.

Furthermore, according to the above-described embodiment, the predetermined selection method includes selecting the minimum or maximum register number among the register numbers in the register management table 21 in a case where there is a register number that has not yet been set in the previously referenced translation timing. Thereby, the information processing device 1 may select the optimum register to be used for the memory operand by using the register management table 21.

Furthermore, according to the above-described embodiment, the predetermined selection method includes selecting the register number of the oldest translation timing in a case where all the previously referenced translation timings are set. Thereby, the information processing device 1 may further select the optimum register to be used for the memory operand by using the register management table 21.

### Others

Note that, in the above-described embodiment, any information indicated in this document or the drawings, including the processing procedures, control procedures, specific names, and various sorts of data and parameters can be arbitrarily modified unless otherwise noted.

Furthermore, each component of each device illustrated in the drawings is functionally conceptual, and is not always physically configured as illustrated in the drawings. For example, specific forms of distribution and integration of each device are not limited to those illustrated in the drawings. For example, all or a part thereof may be configured by being functionally or physically distributed or integrated in optional units according to various types of loads, usage statuses, or the like.

Moreover, all or an optional part of individual processing functions performed in each device may be implemented by a central processing unit (CPU) and a program analyzed and executed by the CPU or may be implemented as hardware by wired logic.

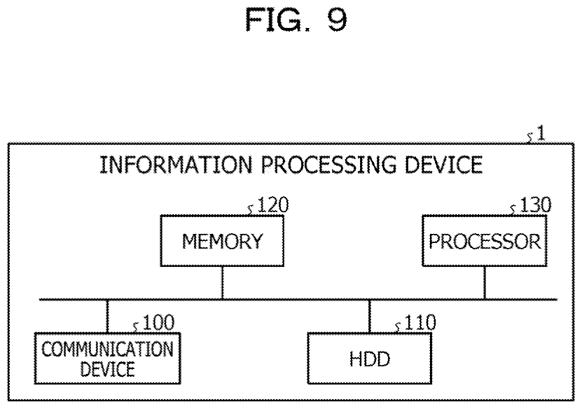

FIG. 9 is a diagram for describing a hardware configuration example. As illustrated in FIG. 9, the information processing device 1 includes a communication device 100, a hard disk drive (HDD) 110, a memory 120, and a processor 130. Furthermore, the respective units illustrated in FIG. 9 are mutually connected by a bus or the like.

The communication device 100 is a network interface card or the like and communicates with another device. The HDD 110 stores databases (DBs) and programs that activate the functions illustrated in FIG. 1.

The processor 130 reads a program that executes processing similar to that of each processing unit illustrated in FIG. 1 from the HDD 110 or the like, and loads it in the memory 120, thereby activating a process that implements each function described with reference to FIG. 1 or the like. For example, this process implements a function similar to that of each processing unit included in the information processing device 1. For example, the processor 130 reads a program having a function similar to the function of the control unit 10 or the like from the HDD 110 or the like. Then, the processor 130 executes a process that executes processing similar to the processing of the control unit 10 or the like.

As described above, the information processing device 1 operates as an information processing device that executes a translation method by reading and executing a program. Furthermore, the information processing device 1 may implement functions similar to the functions of the above-described embodiment by reading the program described above from a recording medium by a medium reading device and executing the read program described above. Note that the program mentioned in other embodiments is not limited to being executed by the information processing device 1. For example, the embodiments may be similarly applied also to a case where another computer or server executes the program, or a case where these computer and server cooperatively execute the program.

This program may be distributed via a network such as the Internet. Furthermore, this program may be recorded on a computer-readable recording medium such as a hard disk, flexible disk (FD), compact disc read only memory (CD-ROM), magneto-optical disk (MO), or digital versatile disc (DVD), and may be executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a translation program for causing a computer to execute processing comprising:
incrementing a counter every time translating a complex instruction set computer (CISC) instruction into a reduced instruction set computer (RISC) instruction;
updating previously referenced translation timing of a register to be used for translation with a value of the counter when translating the CISC instruction with a memory operand into the RISC instruction;
in a case where a use register number that stores a register number to be used for translation of the memory operand is an initial value, selecting the register number by a predetermined selection method, and updating the use register number to the selected register number, by using a register management table in which the register number and the previously referenced translation timing are associated with each other;
in a case where the use register number is not the initial value, and when the use register number is not used in the translation into the RISC instruction, skipping data restoration and data saving for the register indicated by the use register number, and generating an instruction configured to read data of the memory operand by using the register indicated by the use register number; and
generating the RISC instruction equivalent to the CISC instruction.

2. The non-transitory computer-readable recording medium according to claim 1, further comprising:
in the case where the use register number is not the initial value, in a case where the use register number is used in the translation into the RISC instruction, and when the previously referenced translation timing associated with the use register number in the register management table does not exist, skipping the data restoration for the register indicated by the use register number, and setting the use register number to the initial value; and
executing update processing for the use register number.

3. The non-transitory computer-readable recording medium according to claim 2, wherein
the processing of setting the use register number to the initial value includes: in the case where the use register number is not the initial value, in the case where the use register number is used in the translation into the RISC instruction, and when the previously referenced translation timing associated with the use register number in the register management table exists, restoring data for the register indicated by the use register number, and setting the use register number to the initial value; and
executing the update processing for the use register number.

4. The non-transitory computer-readable recording medium according to claim 1, wherein,
when the previously referenced translation timing associated with the selected register number does not exist, the processing of updating the register number includes skipping saving of data for the register indicated by the selected register number, and updating the use register number to the selected register number, by using the register management table.

5. The non-transitory computer-readable recording medium according to claim 1, wherein
the predetermined selection method includes selecting the minimum or maximum register number among the register numbers in the register management table in a case where there is a register number that has not yet been set in the previously referenced translation timing.

6. The non-transitory computer-readable recording medium according to claim 5, wherein
the predetermined selection method includes selecting the register number of the oldest translation timing in a case where all the previously referenced translation timings are set.

7. A translation method comprising:
incrementing, by a computer, a counter every time translating a complex instruction set computer (CISC) instruction into a reduced instruction set computer (RISC) instruction;
updating previously referenced translation timing of a register to be used for translation with a value of the counter when translating the CISC instruction with a memory operand into the RISC instruction;
in a case where a use register number that stores a register number to be used for translation of the memory operand is an initial value, selecting the register number by a predetermined selection method, and updating the use register number to the selected register number, by using a register management table in which the register number and the previously referenced translation timing are associated with each other;
in a case where the use register number is not the initial value, and when the use register number is not used in the translation into the RISC instruction, skipping data restoration and data saving for the register indicated by the use register number, and generating an instruction configured to read data of the memory operand by using the register indicated by the use register number; and
generating the RISC instruction equivalent to the CISC instruction.
